(19) United States
(12) Patent Application Publication
(10) Pub. No.: US 2022/0035079 A1
(43) Pub. Date: Feb. 3, 2022

(54) VARIABLE VOLUME LIQUID LENSES

(71) Applicant: CORNING INCORPORATED, CORNING, NY (US)

(72) Inventors: Raymond Miller Karam, Santa Barbara, CA (US); Shiwen Liu, Goleta, CA (US); Christopher RC Olson, Goleta, CA (US); Ernesto Sanchez, Jr., Ventura, CA (US); Ming Ying, Santa Barbara, CA (US)

(21) Appl. No.: 17/276,964

(22) PCT Filed: Sep. 20, 2019
(86) PCT No.: PCT/US2019/052045

§ 371 Date: Mar. 17, 2021

Related U.S. Application Data
(60) Provisional application No. 62/734,891, filed on Sep. 21, 2018.

(51) Int. Cl. G02B 3/14; G02B 26/00; H04N 5/225

(52) U.S. Cl. CPC G02B 3/14; H04N 5/2254; G02B 26/004

(57) ABSTRACT

A liquid lens can include a chamber with first and second fluids and an interface between the fluids. A first electrode can be insulated from the fluids, and a second electrode can be in electrical communication with the first fluid. A position of the interface can be based at least in part on a voltage applied between the first and second electrodes. A flexure can be configured to cause a window to displace axially along an optical axis to change a volume of the chamber. The flexure can extend laterally outward from the window substantially linearly, and can be formed between a first recess on an outer side of the liquid lens and a second recess on an inner side of the liquid lens. The second recess can extend laterally outward farther than the first recess such that the first recess and the second recess are offset from each other.

### CROSS-REFERENCE TO RELATED APPLICATIONS

This application claims the benefit of priority under 35 U.S.C. § 119 of U.S. Provisional Application No. 62/734,891, filed Sep. 21, 2018, the content of which is incorporated herein by reference in its entirety.

### INCORPORATION BY REFERENCE

PCT Patent Application Publication No. WO 2018/148283, filed Feb. 7, 2018, published Aug. 16, 2018, and titled LIQUID LENSES, is hereby incorporated by reference in its entirety. Various embodiments disclosed herein can use the features and details described in the '283 publication.

### BACKGROUND

### Field of the Disclosure

Some embodiments disclosed herein relate to liquid lenses.

### Description of the Related Art

Although various liquid lenses are known, there remains a need for improved liquid lenses.

### SUMMARY

Disclosed herein are liquid lenses and camera modules comprising liquid lenses.

Disclosed herein is a liquid lens comprising a chamber having a volume, a first fluid contained in the chamber, a second fluid contained in the chamber, and an interface disposed between the first fluid and the second fluid. In some embodiments, one or more first electrodes is insulated from the first fluid and the second fluid and one or more second electrodes is in electrical communication with the first fluid. A position of the interface can be based at least in part on a voltage applied between the first electrode and the second electrode. In some embodiments, a window is configured to transmit light therethrough along an optical axis, a flexure is configured to cause the window to displace axially along the optical axis to change the volume of the chamber. The flexure can extend laterally outward from the window substantially linearly. The flexure can be formed between a first recess on an outer side of the liquid lens and a second recess on an inner side of the liquid lens. The second recess can extend laterally outward farther than the first recess.

Disclosed herein is a liquid lens comprising a chamber having a volume, a first fluid contained in the chamber, a second fluid contained in the chamber, and an interface disposed between the first fluid and the second fluid. In some embodiments, one or more first electrodes is insulated from the first fluid and the second fluid, and one or more second electrodes is in electrical communication with the first fluid. A position of the interface can be based at least in part on a voltage applied between the first electrode and the second electrode. In some embodiments, a window element comprises a window configured to transmit light therethrough along an optical axis, an attachment portion coupled to an underlying structure of the liquid lens, a first recess on a first side of the window element, and a second recess on a second side of the window element. Material between the first recess and the second recess can provide a flexure that extends between the window and the attachment portion. The first recess and the second recess can be offset from each other so that displacement of the window and flexure produces less peak tensile stress than peak compressive stress on the flexure.

Disclosed herein is a camera system comprising a liquid lens and a camera module. In some embodiments, the camera module comprises an imaging sensor and one or more fixed lenses configured to direct light onto the imaging sensor. Operating the camera module can produce heat that causes a change in a focal length of the one or more fixed lenses. In some embodiments, the liquid lens is thermally coupled to the camera module such that at least a portion of the heat from the camera module is transferred to the liquid lens. The heat transferred to the liquid lens can flex the window to produce a change in a focal length of the liquid lens that at least partially counters the change in the focal length of the one or more fixed lenses in the camera module.

### BRIEF DESCRIPTION OF THE DRAWINGS

FIG. 1 is a cross-sectional view of some embodiments of a liquid lens.

FIG. 2 is a cross-sectional view of some embodiments of a liquid lens with a window pushed axially outward.

FIG. 3 is a cross-sectional view of some embodiments of a liquid lens with a window flexed.

FIG. 4 is a cross-sectional view of some embodiments of a liquid lens with a shaped window.

FIG. 5 is a block diagram of some embodiments of a camera system.

FIG. 6 is a flowchart showing some embodiments of a method for designing a liquid lens.

FIG. 7 is a cross-sectional view of some embodiments of a liquid lens with a lower window coupled to a flexible member.

FIG. 8 is a cross-sectional view of some embodiments of a liquid lens with flexible members for both upper and lower windows.

FIG. 9 is a partial cross-sectional view of some embodiments of a liquid lens window element in an unflexed configuration.

FIG. 10 is a partial cross-sectional view of some embodiments of a liquid lens window element in a flexed configuration.

FIG. 11 is a partial perspective view of some embodiments of a window element in a displaced or flexed configuration, showing an upper side thereof.

FIG. 12 is a partial perspective view of some embodiments of a window element in a displaced or flexed configuration, showing a lower side thereof.

FIG. 13 is a partial cross-sectional view of some embodiments of a window element in a displaced or flexed configuration.

FIG. 14 is a partial cross-sectional view of some embodiments of a window element in a displaced or flexed configuration.

FIG. 15 is a partial cross-sectional view of some embodiments of a liquid lens with an upper recess offset from a lower recess in a radially or laterally outward direction.

FIG. 16 is a partial perspective view of some embodiments of a liquid lens with a window without a separate flexure.

### DETAILED DESCRIPTION OF CERTAIN EMBODIMENTS

A liquid lens can have a cavity or chamber that is configured to expand and/or contract, such as to accommodate for thermal expansion and/or contraction (e.g., of the fluids enclosed in the liquid lens). Heat applied to the liquid lens, such as by operation of a camera module associated with the liquid lens, or by ambient temperature changes, etc., can cause thermal expansion in the liquid lens, such as of one or more of the fluids contained in the cavity of the liquid lens. A liquid lens can have a window (e.g., an upper window and/or a lower window) that is configured to move, flex, or bow, such as to alleviate pressure changes in the liquid lens. In some instances, the curvature of the flexed window can change the optical power of the liquid lens, which can defocus, or otherwise degrade, an image produced using the liquid lens. By way of example, in some implementations, portions of the window can deflect (e.g., in a non-spherical manner) by 30 microns, and the flexing of the window can change the optical power of the liquid lens (e.g., the combined optical power of the window and the fluid interface) by several diopters. Also, the flexing of the window can introduce optical aberration (such as spherical and non-spherical aberration) to an image produced using the liquid lens. In some cases, the flexed window can have a non-spherical curvature, an approximately Gaussian curvature, a 3rd or 4th order curvature, or an irregular curvature. Flexing of the window can cause shadowing in the image, such as when using the liquid lens optical-image-stabilization (OIS) function. Also, in some instances, flexing of the window can compromise the structural integrity of the liquid lens, such as if enough heat is applied to the lens, the fluid can expand to the point that the window deflects enough to break.

In some embodiments, a liquid lens can be configured so that the window is displaced (e.g., axially along the optical axis of the liquid lens) instead of or in addition to bowing to accommodate expansion or contraction, so as to reduce or avoid optical aberrations and/or defocusing in the liquid lens. A flexible member, or flexure, can be disposed radially outward or circumferentially around the outside of the window, and the flexible member can deform so that the window translates (e.g., axially along the optical axis or the structural axis) without flexing, or with a reduced or controlled flexing, to compensate for the expansion of the volume inside the liquid lens cavity. In some implementations, the window can flex or bow (e.g., in a spherical manner), such as by an amount less than the flexible member. The window can be designed so that the shape of the flexed window resulting from an amount of heat in the liquid lens produces a change in optical power that at least partially offsets a change in optical power that is produced in a camera module by a corresponding amount of heat. The window and the flexible member can be integrally formed, such as of a glass material. A portion of the material can be removed, such as by etching, from a top side of the material and/or from a bottom side of the material to form one or more annular recesses that provide the flexible member. An upper recess can be offset from a lower recess, which can spread and/or reduce stresses on the flexible member. For example, the tensile stress from deforming the flexible member can be spread over a larger area, as compared to a liquid lens with upper and lower recesses that are not offset, as discussed herein.

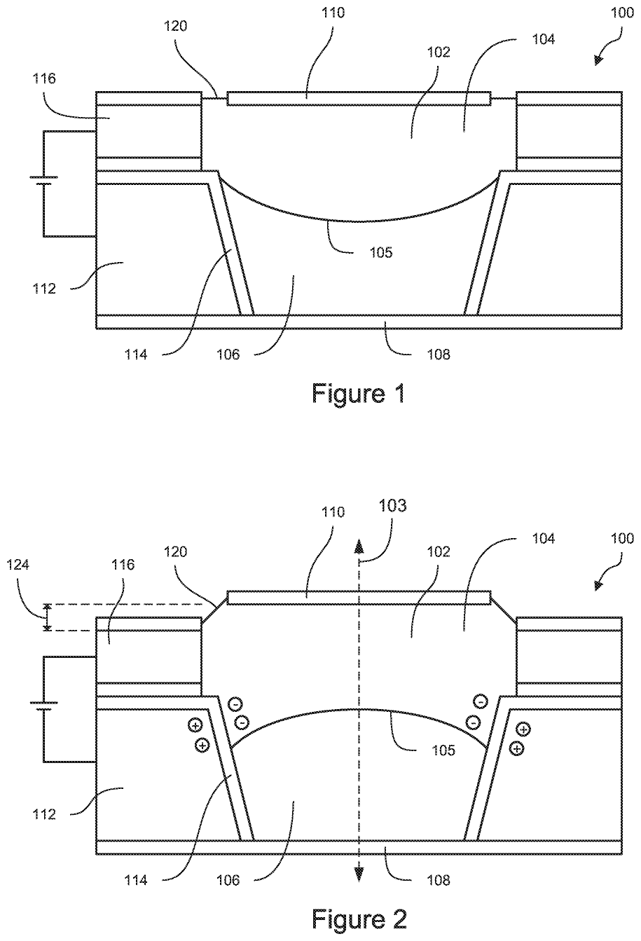

FIG. 1 is a cross-sectional view of an example embodiment of a liquid lens 100. The liquid lens 100 of FIG. 1, as well as the other liquid lenses disclosed herein, can have features that are the same as or similar to the liquid lenses disclosed in the '283 Publication. The liquid lens can have a cavity or chamber 102 that contains at least two fluids, such as polar fluid 104 and non-polar fluid 106 and an interface 105 disposed between the fluids. In some embodiments, the fluids are substantially immiscible, thereby forming a fluid interface 105 where the fluids are in contact with each other. In some embodiments, the fluids are not in contact at the interface 105, such as when a membrane or other barrier is disposed between the fluids. In such embodiments, the fluids may or may not be immiscible. The first fluid 104 can be electrically conductive. The first fluid can be an aqueous solution. The second fluid 106 can be electrically insulating. The second fluid 106 can be an oil. The two fluids 104 and 106 can have sufficiently different refractive indices such that the fluid interface 105, when curved, can refract light with optical power as a lens. The cavity 102 can include a portion having a shape of a frustum or truncated cone. The cavity 102 can have angled side walls. The cavity can have a narrow portion where the side walls are closer together and a wide portion where the side walls are farther apart. The narrow portion can be at or near the bottom end of the cavity, and the wide portion can be at or near the top end of the cavity in the orientation shown, although the liquid lenses 100 disclosed herein can be positioned at various other orientations.

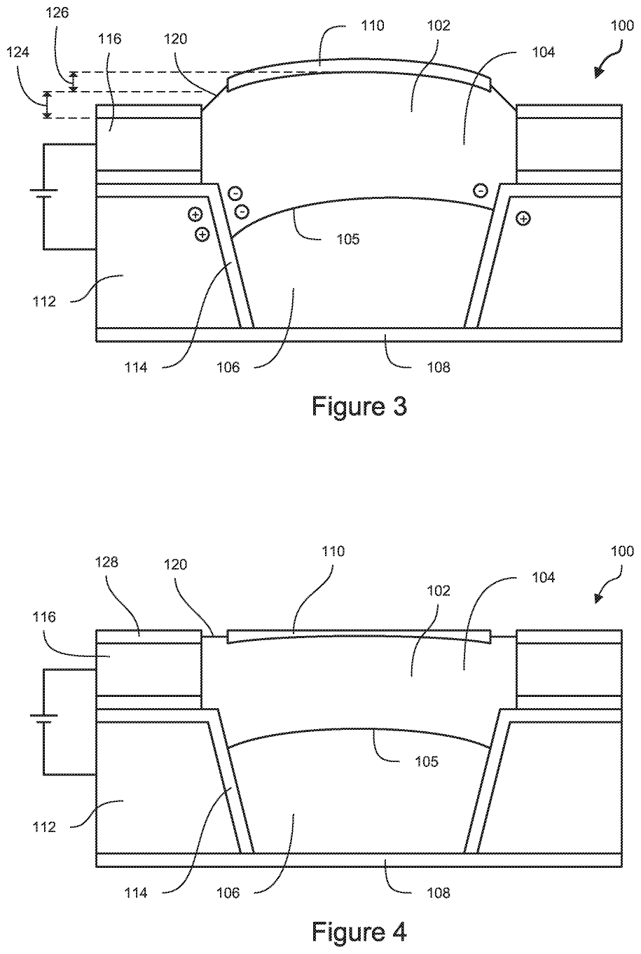

A lower window 108, which can include a transparent plate, can be below the cavity 102, and an upper window 110, which can include a transparent plate, can be above the cavity 102. The lower window 108 and/or the upper window 110 can be sufficiently transparent to transmit light within a determined range of wavelengths for forming an image on an image sensor as described herein. For example, lower window 108 and/or the upper window 110 can have a transmissivity of visible light (e.g., in a wavelength range of 400 nm to 700 nm) of about 50%, about 60%, about 70%, about 80%, about 90%, about 95%, about 99%, about 100%, or any ranges defined by any of the listed values. The lower window 108 can be located at or near the narrow portion of the cavity 102, and/or the upper window 110 can be located at or near the wide portion of the cavity 102. A first one or more electrodes 112 can be insulated from the fluids in the cavity by an insulation material 114. For example, the first one or more electrodes 112 can define the sidewalls of the cavity 102 and/or can be disposed on the sidewalls of the cavity 102, and the insulation material 114 can be disposed on the first one or more electrodes 112 or a portion thereof (e.g., the portion within the cavity 102). A second one or more electrodes 116 can be in electrical communication with the polar fluid 104. For example, the second one or more electrodes 116 can be disposed at least partially within the cavity 102 and uncovered by the insulation material 114. The second one or more electrodes 116 can be in contact with the polar fluid 104. In some embodiments, the second one or more electrodes 116 can be capacitively coupled to the polar fluid 104. Voltages can be applied between the electrodes 112 and 116 to control the shape of the fluid interface 105 between the fluids 104 and 106, such as to vary the focal length of the liquid lens. For example, FIG. 1 shows a liquid lens 100 with the fluid interface 105 at a first position (e.g., which can be a resting position corresponding to no driving voltage), and FIG. 2 shows a liquid lens 100 with the fluid interface 105 at a second position (e.g., which can correspond to a first driving voltage value). The liquid lens 100 can produce different amounts of optical power by varying the driving voltage. In some embodiments, the liquid lens 100 can tilt the fluid interface 105, such as to implement optical image stabilization. The one or more electrodes 112 can include multiple electrodes (e.g., distributed circumferentially about the cavity 102), so that different voltage differentials can be applied to different portions of the liquid lens to tilt the fluid interface 105, as shown, for example, in FIG. 3.

The liquid lens 100 can include a flexible member 120 that can be configured to deform to enable the window 110 to move (e.g., axially along the axis of symmetry and/or the optical axis 103 of the liquid lens 100), as can be seen in FIG. 2. In the embodiment of FIG. 2, the window 110 has been pushed axially outward by a distance 124. For example, if heat is applied to the liquid lens 100, components of the liquid lens 100 (e.g., one or both of the fluids 104 and 106) can expand (e.g., due to thermal expansion), which can push the upper window 110 to be displaced axially outwardly by the distance 124. If less heat were applied, the window 110 would deflect by a smaller distance, and if more heat were applied, the window 110 would deflect by a larger distance.

The flexible member 120 can be positioned at the edges of the cavity 102, at the perimeter of the upper window 110, and/or radially or laterally outward from the upper window 110. The flexible member 120 can be rotationally symmetrical about the optical axis of the liquid lens. The flexible member 120 can extend a full 360 degrees and can surround the upper window 110. In some embodiments, the flexible member 120 can be made of the same material as the upper window 110 (e.g., a glass material). For example, the flexible member 120 and the upper window 110 can be formed integrally from a glass substrate. The flexible member 120 can have a thickness that is less than the thickness of the window 110 to enable the flexible member 120 to deform as discussed herein. For example, the flexible member 120 can have a thickness that is about 70%, about 60%, about 50%, about 40%, about 30%, about 20%, about 10%, or about 5% of the thickness of the window 110, or any values therebetween, or any ranges bounded by any combination of these values, although other values outside these ranges could be used in some implementations. In some embodiments, the flexible member 120 is a flexible area disposed directly adjacent the radially outer edge of the window 110. In some embodiments, the flexible member 120 can be an outer portion of the window 110 that is thinner than an inner portion of the window 110.

In some embodiments, the upper window 110 remains substantially planar when it is displaced, for example such that the optical power of the liquid lens 100 is substantially not changed by the shape of the displaced upper window 110. In some embodiments, the liquid lens 110 can be configured such that a temperature change from 20 degrees C. to 60 degrees C. produces a change of optical power of about 5 diopters, about 4 diopters, about 3 diopters, about 2 diopters, about 1 diopter, about 0.5 diopters, about 0.25 diopters, or less, or any values therebetween, or any ranges bounded by any combination of these values, although other values can be used in some instances. The upper window 110 can have a diameter of about 20 mm, about 15 mm, about 12 mm, about 10 mm, about 8 mm, about 6 mm, about 5 mm, about 4 mm, about 3 mm, about 2 mm, or less, or any values therebetween, or any ranges bounded by any combination of these values, although other sizes can be used in some implementations.

With reference to FIG. 3, in some embodiments, the window 110 can be configured to flex as well as the flexure or flexible member 120. The window 110 can be less flexible (e.g., stiffer or more rigid) than the flexible member 120. When flexed, the axial displacement distance 124 from the flexible member 120 can be greater than the axial displacement distance 126 of the flexed window 110. The ratio of the axial displacement distance 124 from the flexure 120 to the axial displacement distance 126 from the window 110 (e.g., at a temperature of 60 degrees C. or another suitable measurement temperature that causes the axial deflection) can be about 1 to 1, about 1.5 to 1, about 2 to 1, about 2.5 to 1, about 3 to 1, about 4 to 1, about 5 to 1, about 6 to 1, about 8 to 1, about 10 to 1, about 12 to 1, about 15 to 1, about 20 to 1, about 25 to 1, about 30 to 1, about 40 to 1, about 50 to 1, about 60 to 1, or any values therebetween, or any ranges bounded by any combination of these ratios, although some embodiments can produce other ratios as well. The axial displacement distance 126 of the window 110 can be about 1%, about 1.5%, about 2%, about 3%, about 4%, about 5%, about 7%, about 10%, about 15%, about 25%, about 50%, about 75%, or more of the axial displacement distance 124 of the flexible member 120, or any values therebetween, or any ranges bounded therein, although other configurations can be implemented. For example, the displacement distance 126 can be larger than the displacement distance 124, in some implementations. The ratio of the total axial displacement distance (e.g., the sum of distances 124 and 126) to the axial displacement distance 126 bending of the window 110 can be about 2 to 1, about 2.5 to 1, about 3 to 1, about 4 to 1, about 5 to 1, about 6 to 1, about 8 to 1, about 10 to 1, about 12 to 1, about 15 to 1, about 20 to 1, about 25 to 1, about 30 to 1, about 50 to 1, about 75 to 1, or more, or any values therebetween, or any ranges bounded by any combination of these ratios, although some embodiments can produce other ratios as well. The bending of the flexible member 120 (e.g., distance 124) can produce about 50%, about 60%, about 70%, about 80%, about 85%, about 90%, about 93%, about 95%, about 96%, about 97%, about 98%, or about 99% of the total window displacement (e.g., distance 124 plus distance 126), such as in the axial direction, or any values therebetween, or any ranges bounded by any combination of these values, although other implementations are also possible.

In some embodiments, the flexible member 120 and/or the window 110 can be configured so that the curvature of the window 110 is substantially spherical, or is substantially paraboloidal, or has a third or second order curvature shape. Other curvature shapes are possible for the flexed window 110. The flexible member 120 and/or the window 110 can be configured so that the window 110 can be displaced (e.g., flexed in some embodiments) without introducing substantial spherical aberration, and in some cases without introducing substantial optical aberration, to images produced by the liquid lens. The liquid lens 100, when operated between 20 degrees C. and 60 degrees C., can produce wavefront error (e.g., wavefront error introduced upon increasing the operating temperature from 20 degrees C. to 60 degrees C.) of about 1 micron, about 0.7 microns, about 0.5 microns, about 0.4 microns, about 0.3 microns, about 0.2 microns, about 0.1 microns, or less, or any values therebetween, or any ranges bounded by any combination of these values, although other values are also possible in some embodiments.

With reference to FIG. 4, the liquid lens 100 can have a shaped window 110. The window 110 can have areas (e.g., concentric areas) of different thicknesses and/or of different materials selected such that the window 110 takes a particular shape when flexed (e.g., substantially spherical, substantial paraboloidal, etc.). The window 110 can have areas of continuously changing thickness. One or both surfaces of the window 110 can be curved when at rest. In the embodiment of FIG. 4, the window is plano-concave, having a substantially planar top or outer surface and a concave bottom or inner surface. This configuration can cause the window 110 to flex more at the thinner center area and to flex less at the thicker outer area. Many variations are possible. The window 110 can be plano-convex, for example having a substantially planar top or outer surface and a convex bottom or inner surface. A plano-convex window 110 can cause the thicker center portion to flex less than the thinner outer portions of the window 110. In some cases, a top or outer surface that is planar can reduce optical power introduced by the window 110 when not flexed, especially if the material of the window 110 has an index of refraction that is close to the index of refraction for the polar fluid 104 (e.g., such that the interface between the polar fluid and the curved bottom or inner surface of the window does not significantly refract light). In some cases, both the top or outer surface and the bottom or inner surface can be curved (e.g., having a biconcave, biconvex, or meniscus shape). Various different window shapes can be used depending on the desired flexure of the window 110.

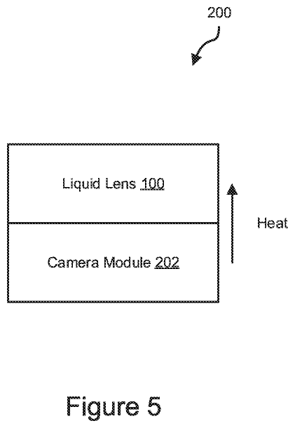

In some embodiments, the window 110 can flex and can introduce optical power to compensate for changes in optical power that occur in a corresponding camera module when heat is generated. FIG. 5 shows an example embodiment of a camera system 200. The camera system 200 can include a liquid lens 100, which can have features described in connection with any of the liquid lenses disclosed herein, and a camera module 202. The camera module 202 can include an imaging sensor (e.g., a charged coupled device (CCD) or complementary metal-oxide-semiconductor (CMOS) sensor), and electronic circuitry. In some embodiments, the camera module 202 can include one or more fixed lenses (e.g., a lens stack) and/or one or more movable lenses, or other focusing optical elements. In some embodiments, the liquid lens 100 can operate with the camera module to provide variable focus and/or optical image stabilization. In some embodiments, operation of the camera module 202 can generate heat, such as from the electronic circuitry and/or moving components like movable lenses. Heat generated from the camera module 202 can be transferred to the liquid lens 100, and can cause thermal expansion. The liquid lens 100 can accommodate the thermal expansion (e.g., by displacing and/or flexing the window 110), as discussed herein.

In some cases, heat from the camera module 202 can affect one or more optical properties of the camera module 202. For example, the heat can cause thermal expansion in the camera module components, such as the one or more fixed or movable lenses. As the camera module 202 operates and generates heat, the optical power of the camera module 202 can change. For example, the heat can cause thermal expansion that causes the one or more lenses to expand and/or causes mounting components to shift the positions of the one or more lenses. In some cases, heat from the camera module 202 can cause the focal length of the camera module to lengthen. This can result in some defocusing of the image produced by the camera module 202. Many optical effects can result from the heat of the camera module 202. In some cases, the heat may cause the focal length of the camera module to shorten.

As mentioned above, heat from the camera module 202 can be transferred to the corresponding liquid lens 100, and can cause the window 110 to move (e.g., flex), which can affect one or more optical properties of the liquid lens 100. The optical effect of the heat from the camera module 202 transferred to the liquid lens 100 can at least in part counteract the optical effects that are produced in the camera module 202 by the heat of the camera module 202. For example, if an amount of heat in the camera module 202 causes the focal length of the one or more lenses of the camera module to lengthen, the corresponding heat transferred to the liquid lens 100 can cause the focal length of the liquid lens to shorten. If an amount of heat in the camera module 202 causes the focal length of the one or more lenses of the camera module to shorten, the corresponding heat transferred to the liquid lens 100 can cause the focal length of the liquid lens to lengthen. The liquid lens 100 can be configured such that if an amount of heat in the camera module 202 causes the optical power of the camera module to change by an amount (e.g., 1 diopter), the corresponding heat transferred to the liquid lens 100 causes the optical power of the liquid lens to change in an opposite corresponding amount (e.g., −1 diopter). In some embodiments, the optical effect of the heat in the liquid lens 100 can counter the optical effect of the corresponding heat in the camera module 202 to within a variance of about 2%, about 5%, about 10%, about 15%, about 20%, about 25%, about 30%, about 40%, or about 50%, or any values therebetween, or any ranges bounded by any of these values, although values outside these ranges could be used in some implementations. For example, heat in the camera module that produces a change in optical power of 1 diopter can produce heat in the liquid lens that causes the window to move to produce a change in optical power of −0.5 diopters, −0.75 diopters, −1 diopter, −1.25 diopters, −1.5 diopters, or any values therebetween.

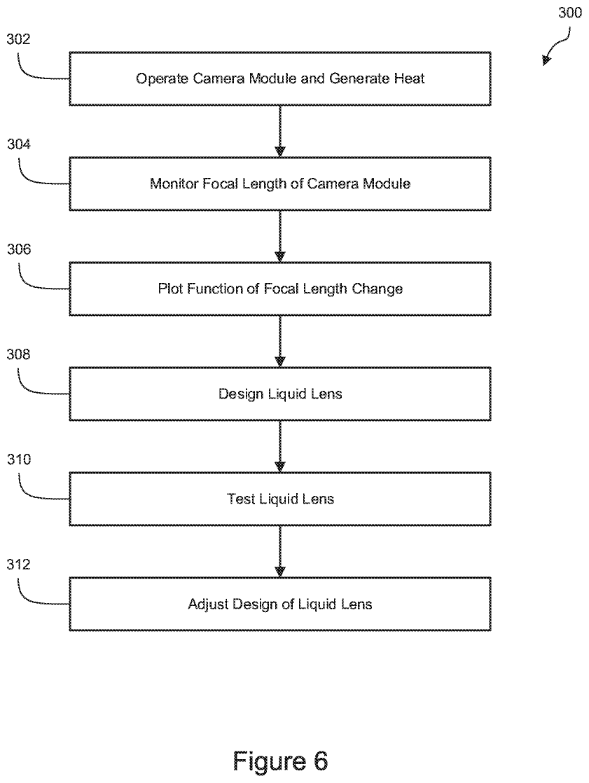

FIG. 6 is a flowchart showing an example method 300 for designing a liquid lens 100, such as to have a window 110 that is configured to counteract optical effects produced by heat in the camera module 202. At block 302, the camera module 202 can be operated to generate heat in the camera module 202. In some embodiments, heat can be applied from an external heat source, such as to raise the ambient temperature at the camera module 202. At block 304, the focal length and/or optical power of the camera module 202 can be monitored as the temperature changes due to the generated heat. The example of FIG. 6 is provided with respect to changes in optical power or focal length, although a similar method can be applied to compensate for changes in other optical properties resulting from generated heat. At block 306, the function of the focal length or optical power changes can be plotted with respect to the changes in temperature. This can provide an indication of the desired corresponding response in the liquid lens 100.

At block 308, the liquid lens 100 can be designed. In some embodiments, various aspects of the liquid lens 100 may be constrained by application parameters, or may have been designed prior to block 308. At block 308, one or more aspects of the liquid lens 100 (e.g., the window 110 and/or the flexible member 120) can be designed to cause the liquid lens 100 to at least partially counteract the changes in optical power or focal length plotted at block 306 as heat is transferred to the liquid lens 100. In some embodiments, computer modeling can be used to design the one or more aspects of the liquid lens 100, such as to predict how particular window shapes will react to changes in temperature in the liquid lens 100. In some embodiments, the temperature in the liquid lens 100 can be different than the temperature in the camera module 202. For example, some heat may be lost to the ambient air, and the manner in which the liquid lens 100 is coupled to the camera module 202 can affect how much heat is transferred from the camera module 202 to the liquid lens 100. In some embodiments, the predicted heat transfer from the camera module 202 to the liquid lens 100 can be used to influence the design of the liquid lens 100. For example, if a relatively small amount of heat is transferred from the camera module 202 to the liquid lens 100, then the window 110 may be designed thinner (e.g., less stiff or less rigid) in order to enable the window 110 to flex sufficiently to provide enough counteracting optical power when only the relative small amount of heat is transferred to the liquid lens 100. Computer modeling can be used to predict or estimate heat transfer from the camera module 202 to the liquid lens 100. Example parameters of the liquid lens 100 that can be adjusted to control the optical power change due to heat include the thickness of the window 110, the thickness of the flexible member 120, the size and/or configuration of the flexible member 120, the size (e.g., diameter) of the window 110, the size of the cavity 102, the material used for the window 110 and/or the flexible member 120, and other features of the liquid lenses 100 discussed herein.

At block 310, the liquid lens 100 can be tested. In some cases, a liquid lens 100 can be manufactured and physically tested. For example, the liquid lens 100 and camera module 202 can be joined, and the camera module 202 can be operated to produce heat. The focal length or optical power of the camera system 200 that includes both the camera module 202 and the liquid lens 100 can be monitored as heat is generated and the temperature rises. At block 312, the design of the liquid lens 100 can optionally be adjusted, such as in view of the results of the testing at block 310. If the focal length or optical power of the camera system 200 changes more than desired as heat is generated by the camera module, the design of the liquid lens 100 can be adjusted to better counteract the optical effects of the heat in the camera module. In some embodiments, the liquid lens 100 can be tested at block 310 without the camera module 202. Heat can be applied to the liquid lens, and the changes in optical power or focal length can be monitored and compared to the changes in optical power of focal length in the camera module 202. In some embodiments, the liquid lens 310 can be tested using computer modeling, rather than by empirically testing a manufactured sample. Various blocks of the method 300 can be repeated. For example, multiple rounds of liquid lens testing (block 310) and liquid lens design adjustments (block 312) can be performed. In some embodiments, adjustments can be made to the camera module 202 as well or instead, and/or adjustments can be made to the mounting mechanism for coupling the liquid lens 101 to the camera module 202 (e.g., to increase or decrease the amount of heat transferred to the liquid lens 100). In some embodiments, multiple camera modules 202 and liquid lenses 100 can be tested, such as to improve accuracy of the testing. For example, blocks 302 and 304 can be performed multiple times (e.g., 20, 50, 100 times, or more) and the plot of block 306 can combine (e.g., average) the various results. Similarly, multiple liquid lenses can be manufactured and tested, such as to improve accuracy of the testing.

Many variations are possible. For example, the method can skip plotting the function of change in the focal length or optical power at block 306. A computer modeling program can use the data from testing the camera module 202 to design a recommended liquid lens or to produce design parameters without generating the plot at block 306. In some embodiments, block 312 can be skipped, such as if no adjustment is needed. In some embodiments, all the testing and design can be performed using computer modeling.

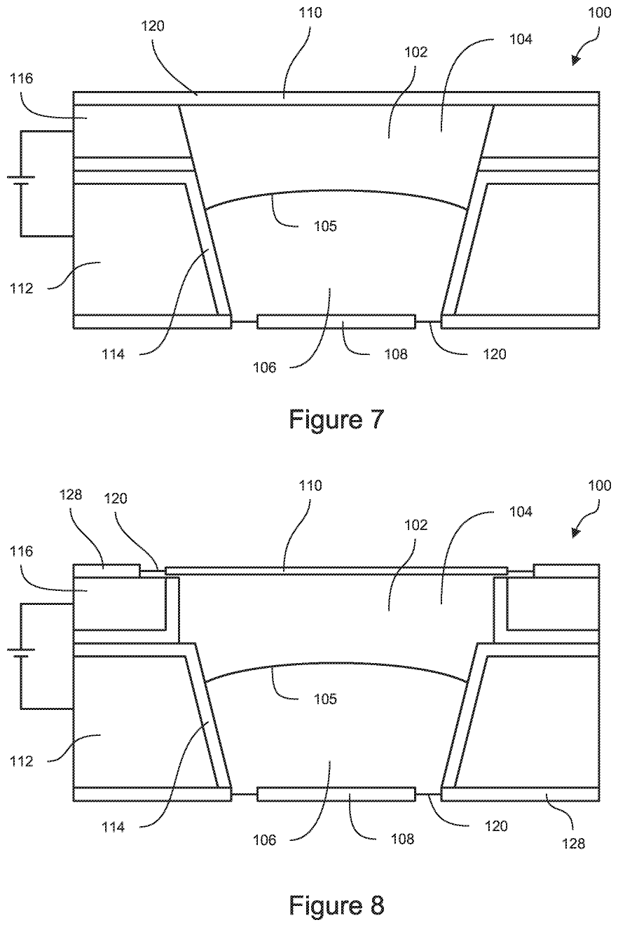

Although various embodiments are discussed herein as relating to the upper window 110, these features can also be applied to the lower window 108 (e.g., in addition to or instead of the upper window 110). In some embodiments, either or both of the upper window 110 and lower window 108 can have a flexible member 120 and/or can be configured to move or flex, as disclosed herein. FIG. 7 shows an example embodiment of a liquid lens 100 having a lower window 108 (e.g., at or near the narrow end of the cavity 102) that is coupled to a flexible member 120 so that the lower window 108 can be displaced (e.g., axially downward) to accommodate thermal expansion due to heat. FIG. 8 shows an example embodiment of a liquid lens 100 having flexible members 120 for both the upper window 110 and the lower window 108, so that both windows 108 and 110 can be displaced (e.g., axially) to accommodate thermal expansion (e.g., of the fluids 104 and 106). The lower window 108 and upper window 110 can be configured to move in opposite directions in response to changes in temperature. The lower window 108 and upper window 110 can be configured to move by the same amount or by different amounts in response to changes in temperature. The lower window 108 can move (e.g., axially) a distance that is about 50%, about 60%, about 70%, about 80%, about 90%, about 100%, about 110%, about 120%, about 130%, about 140%, or about 150% of the distance that the upper window 110 moves (e.g., axially) in response to a change in temperature. The distance that the windows 108 and/or 110 move can be measured at the most displaced portion of the windows 108 and/or 110 (e.g., at the apex of the bowing window shape). The various features, parameters, methods, etc. discussed herein can be implemented with a flexible member 120 for only the upper window 110, with a flexible member 120 for only the lower window 108, or with flexible members 120 for both the upper window 110 and the lower window 108. Also, although various embodiments are discussed in connection with increasing the volume of the cavity or chamber 102 to accommodate thermal expansion, the liquid lenses 100 discussed herein can be configured to decrease the volume of the cavity or chamber 102 to accommodate thermal contraction (e.g., due to cooling temperatures). For example, the window 110 can be displaced (e.g., axially) towards the fluid interface 105 or into the cavity 102, which can reduce the volume of the cavity 102. The window 110 can also bow inwardly towards the fluid interface 105 to reduce the volume of the chamber or cavity 102.

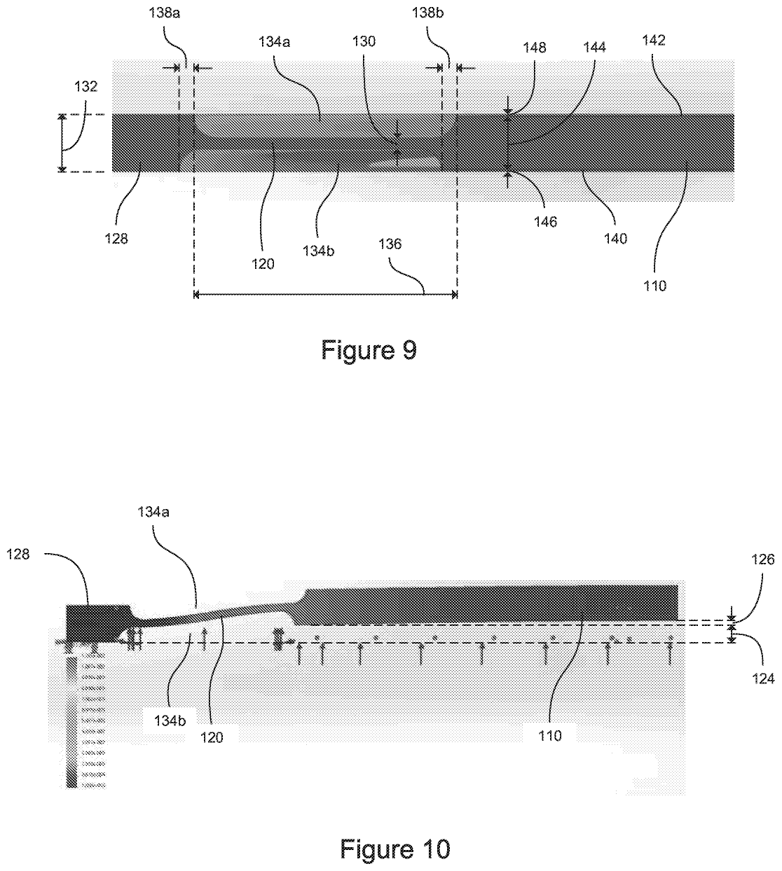

FIG. 9 is a partial cross-sectional view of a liquid lens window element in an unflexed configuration. FIG. 10 is a partial cross-sectional view of the liquid lens window element in a flexed configuration, with shading to indicate amounts of deflection for various portions of the window element. In FIGS. 9-10, the cross-sectional views were taken of a “pie slice” of the window element, so that about one half of the window element is shown in the partial cross-sectional views. The window element embodiments disclosed herein can be used for the upper window 110 and/or the lower window 108, but are generally discussed in connection with the upper window 110 for simplicity of discussion. The window element can include a transparent window 110, a flexible member 120, and an attachment portion 128. The transparent window 110 can be located at a center region, with the flexure 120 positioned radially or laterally outward from the transparent window 110, and/or with the attachment portion 128 positioned radially or laterally outward from the flexible member 120. The attachment portion 128 can be located at the periphery of the window element. The attachment portion 128 can be attached to a substrate or other underlying support structure or material (e.g., using a room temperature bonding technique, or laser welding, or an adhesive, or a fastener, or any other suitable manner) to position the window element on the liquid lens 100, as can be seen in FIGS. 1 to 4, for example. In some embodiments, the window 110, the flexible member 120, and the attachment portion 128 comprise a unitary structure (e.g., formed from a unitary substrate material, such as a glass substrate).

The flexible member 120 (which is sometimes called a flexure) can couple the attachment portion 128 to the transparent window 110. The flexible member 120 can be more flexible or compliant than the transparent window 110 and/or more flexible or compliant than the attachment portion 128. The flexure 120 can be thinner than the transparent window 110 and/or thinner than the attachment portion 128. For example, the material of the flexible member 120 can have a thickness 130 that is about 5%, about 10%, about 15%, about 20%, about 25%, about 30%, about 35%, about 40%, about 45%, about 50%, about 55%, about 60%, about 65%, about 70%, or about 75% of the thickness 132 of either or both of the transparent window 110 and the attachment portion 128, or any values therebetween, or any ranges bounded by any combination of these values, although other values could also be used in some implementations. A first recess 134a and a second recess 134b can be positioned on opposite sides of the material to form the flexure 120 at the material between the two recesses 134a-b. The recesses 134a and 134b can be at least partially symmetrical, for example having the same shape, depth, size, and/or position. In some embodiments, the recess 134a can be offset radially or laterally from the recess 134b, which can distribute forces (e.g., tensile forces) across a larger area as the flexure 120 deforms, as discussed herein.

In some cases, the transparent window 110 and the attachment portion 128 can have the same thickness 132, or either can have a thickness that is thicker or thinner than the other by about 1%, about 3%, about 5%, about 10%, about 15%, about 20%, about 25%, about 30%, or any values therebetween, or any ranges bounded by any combination of these values. For example, as can be seen in FIG. 9, the window 110 can have a thickness 144 that is smaller than the thickness 132 of the attachment portion 128. In some embodiments, the side of the window element facing towards the cavity 102 (e.g., the bottom side of the upper window 110) can have a depression 140. The depression 140 can extend across part or all of the transparent window 110. The recess 140 can have a depth 146, as shown in FIG. 9. In some embodiments, the side of the window element facing away from the cavity 102 (e.g., the top side of the upper window 110) can have a depression 142. The depression 142 can extend across part or all of the transparent window 110. The recess 140 can have a depth 148, as shown in FIG. 9.

In some embodiments, the depression 140 can produce a gap between the window 110 and the underlying structure of the liquid lens 100 (e.g., an insulating material 114, such as parylene), as can be seen in connection with the window 110 of FIG. 8, for example. The gap can impede the flexure 120 and/or the window 110 from contacting the underlying structure. The gap can provide an electrical connection between an electrode 116 and fluid 104 in the liquid lens. FIG. 8 shows an example embodiment of a liquid lens 100 that has a thinned underside of the upper window 110. The truncated cone structure, or other support structure, can extend up to the level of the attachment portion 128 for the window element. The depression 140 can impede the flexure 120 and/or the window 110 from touching the top surface or end of the truncated cone structure, or other underlying structure of the liquid lens, such as an insulating layer 114 (e.g., parylene). In some cases, the second electrode 116 can contact the polar fluid 104 at a location that is above the truncated cone structure, or that is on a top surface of the truncated cone structure. The second electrode 116 can contact the polar fluid 104 at a location that is directly below the flexure 120. The depression 140 can produce a gap so that the polar fluid 104 can fill the area under the flexure 120 and contact the second electrode 116. In some embodiments, some or all of the flexure 120 can be positioned radially outside the truncated cone portion of the cavity 102, as can be seen in FIG. 8.

In some embodiments, the depressions 140 and/or 142 can impede the window from being damaged during manufacturing, during assembly, and/or during operation. Because the attachment portion 128 is thicker than the window 110, the entire window element (e.g., attachment portion 128, flexure 120, and window 110) can be laid on a surface so that the window element is supported by the attachment portion 128 while the window 110 is suspended above the surface. This can impede the window 110 from being scratched or otherwise damaged, which could degrade the optical quality of the liquid lens. Both sides of the window 110 can be recessed, which can provide protection to both sides, or in some cases, only one side or the other of the window 110 is recessed.

Many variations are possible. For example, in some embodiments, the depressions 140 and/or 142 can be omitted. The window 110 and the attachment portion 128 can have substantially the same thickness. A liquid lens 100 can have a post or other raised structure for engaging the attachment portion 128, which can raise the window away from underlying structure of the liquid lens. A liquid lens 100 can have the flexure 120 suspended over the truncated cone or another portion of the cavity 102 (e.g., see FIG. 1). In some cases, the depression 140 and/or 142 can extend across only a portion of the window. The depression 140 and/or 142 can be an annular depression, which can surround a portion of the window 110. In some cases, the depression 140 and/or 142 can overlap onto part of the window 110, but does not extend to the center region of the window 110 (e.g., does not extend to the portion of the window 110 that transmits light that reaches the sensor to generate an image).

The depressions 140 and/or 142 (and the recesses 134) can be formed by removing material (such as by etching, grinding, ablating, milling, or any other suitable manner). The depressions 140 and/or 142 can be formed before or after the recesses 134a-b that provide the flexure 120. For example, the depression 140 can be formed on one side of a glass plate (e.g., using etching or any other suitable technique), and the depression 140 can be formed on the other side of the glass plate (e.g., using etching or any other suitable technique), simultaneously or in series. Masking can be used so that material is removed from only portions of the window element. The recess 134a can be formed in the base of the depression 142 (e.g., using etching or any other suitable technique). The recess 134b can be formed in the base of depression 140, such as on the other side of the glass plate (e.g., using etching or any other suitable technique) either before or after the depression 142 and/or the recess 134a. In some cases, the depression 140 can be formed after the recess 134b. In some cases, the depression 142 can be formed after the recess 134a. For example, forming the depressions 140 and/or 142 would reduce the depth of the recesses 134b and 134a, in some implementations.

The flexure 120 can be integrally formed of the same material (e.g., a glass material) as the transparent window 110 and/or the attachment portion 128, for example as one integral piece. Various types of transparent materials can be used, such as glass, ceramic, glass-ceramic, or polymeric materials. For example, the transparent material can include silicate glass (e.g., aluminosilicate glass, borosilicate glass), quartz, acrylic (e.g., Poly(methyl methacrylate) (PMMA), polycarbonate, etc. The window element can be formed from a piece (e.g., a plate) of transparent material (e.g., glass) having a thickness 132. Material can be removed to form the thinner region (e.g., having a thickness of 130) of the flexure 120. Etching, photolithography, laser ablation, milling, computer numerical control (CNC) milling, grinding, or any other suitable technique can be used. Surprisingly, it was discovered that the thin glass flexure 120 can bend without breaking, as shown for example in FIG. 10, even though glass is generally a brittle material.

The flexure 120 can be a ring flexure that surrounds the window 110. One or more annular recesses 134a-b can be formed in the material (e.g., the glass plate). The recesses 134a-b can extend a full 360 degrees to form a closed shape, such as a circle, although other shapes such as an ellipse, a square, rectangle or other polygon can be used. The recesses 124a-b can be concentric, such as having the same center point, but different radii or different widths. A first recess 134a can be positioned adjacent to the transparent window 110. The radially inner edge of the recess 134a can define the outer perimeter of the transparent window 110. By way of example, the first recess 134a can be positioned on a top side, and a second recess 134b can be positioned on a bottom side. The material between the recesses 134a and 134b can have a thickness 130. The recesses 134a-b can have substantially the same depth. The recesses 134a-b can have substantially the same cross-sectional shape, cross-sectional size, length, and/or depth. The cross-sectional shape of one recess 134a can be inverted compared to the cross-sectional shape of the other recess 134b. The recesses 134a-b can have flat base with curved (e.g., rounded) side walls, although various other suitable shapes can be used, such as a trapezoidal cross-sectional shape, a semicircle, partial ellipse, a triangle, a square, a rectangle, or other polygonal shape. The recesses 134a-b can have the same size and shape except that the radius or width of the positions of the recesses 134a-b can vary.

FIG. 10 shows the flexure 120 and the transparent window 110 in a flexed state, such as can be induced by thermal expansion in the liquid lens 100 (e.g., by heating the liquid lens 100 to a temperature of 60 degrees C.). Because the flexure 120 is thinner and more flexible (e.g., more compliant) than the transparent window 110, the flexure 120 is deformed more than the transparent window 110. The displacement distance 124 for the flexure 120 can be greater than the displacement distance 126 for the transparent window 110, as discussed herein. The ratio of the axial displacement distance 124 from the flexure 120 to the axial displacement distance 126 from the window 110 can be about 1 to 1, about 1.5 to 1, about 2 to 1, about 2.5 to 1, about 3 to 1, about 4 to 1, about 5 to 1, about 6 to 1, about 8 to 1, about 10 to 1, about 12 to 1, about 15 to 1, about 20 to 1, about 25 to 1, or any values therebetween, or any ranges bounded by any combination of these ratios, although some embodiments can produce other ratios as well. The ratio of the total axial displacement distance (e.g., the sum of distances 124 and 126) to the axial displacement distance 126 of the window 110 can be about 2 to 1, about 2.5 to 1, about 3 to 1, about 4 to 1, about 5 to 1, about 6 to 1, about 8 to 1, about 10 to 1, about 12 to 1, about 15 to 1, about 20 to 1, about 25 to 1, about 30 to 1, about 40 to 1, or any values therebetween, or any ranges bounded by any combination of these ratios, although some embodiments can produce other ratios as well.

The window element (e.g., formed from a glass plate) can have a thickness (e.g., thickness 132 in FIG. 9) of about 25 microns, about 30 microns, about 40 microns, about 50 microns, about 60 microns, about 70 microns, about 80 microns, about 90 microns, about 100 microns, about 110 microns, about 115 microns, about 120 microns, about 125 microns, about 130 microns, about 140 microns, about 150 microns, about 175 microns, about 200 microns, about 250 microns, or more, or any values therebetween, or any ranges bounded by any combination of these values, although other sizes can be used in some embodiments (e.g., for larger or smaller scale liquid lenses). In some cases, the attachment portion 128 and/or the window 110 can have a thickness of about 25 microns, about 30 microns, about 40 microns, about 50 microns, about 60 microns, about 70 microns, about 80 microns, about 90 microns, about 100 microns, about 110 microns, about 115 microns, about 120 microns, about 125 microns, about 130 microns, about 140 microns, about 150 microns, about 175 microns, about 200 microns, about 250 microns, or more, or any values therebetween, or any ranges bounded by any combination of these values, although other sizes can be used in some embodiments (e.g., for larger or smaller scale liquid lenses). The window 110 can have the full thickness of the plate (e.g., the same as the thickness 132 of the attachment portion 128), or the window 110 can have a thickness 144 that is reduced by the thickness 146 of the depression 140 and/or the thickness 148 of the depression 142. In some embodiments, the depressions 140 and/or 142 can have corresponding thicknesses 146 and/or 148 of about 1 microns, about 1.5 microns, about 2 microns, about 2.5 microns, about 3 microns, about 3.5 microns, about 4 microns, about 4.5 microns, about 5 microns, about 6 microns, about 7 microns, about 8 microns, about 9 microns, about 10 microns, about 12 microns, about 15 microns, or any values therebetween, or any ranges bounded by any combination of these values, although other sizes can also be used. The thickness 144 of the window 110 can be the same as the thickness 132 of the attachment portion 128, or the same as the material (e.g., glass plate) used to form the window element, as discussed herein, or the thickness 144 of the window 110 can be lower than any of these values or ranges by 1 microns, about 1.5 microns, about 2 microns, about 2.5 microns, about 3 microns, about 3.5 microns, about 4 microns, about 4.5 microns, about 5 microns, about 6 microns, about 7 microns, about 8 microns, about 9 microns, about 10 microns, about 12 microns, about 15 microns, about 20 microns, about 25 microns, about 30 microns, or any values therebetween, or any ranges bounded by any combination of these values, although other sizes can also be used.

The flexure 120 (e.g., formed by a wall between the recesses 134a and 134b) can have a thickness 130 of about 5 microns, about 7 microns, about 10 microns, about 12 microns, about 15 microns, about 17 microns, about 20 microns, about 25 microns, about 30 microns, about 35 microns, about 40 microns, about 50 microns, or any values therebetween, or any ranges bounded by any combination of these values, although other sizes can also be used. The recesses 134a and/or 134b can have a depth of about 5 microns, about 7 microns, about 10 microns, about 12 microns, about 15 microns, about 17 microns, about 20 microns, about 25 microns, about 30 microns, about 35 microns, about 40 microns, about 45 microns, about 47 microns, about 50 microns, about 55 microns, about 60 microns, about 70 microns, about 80 microns, about 90 microns, about 100 microns, about 125 microns, or any values therebetween, or any ranges bounded by any combination of these values. The recesses 134a and/or 134b can have a width 136 of about 20 microns, about 25 microns, about 30 microns, about 35 microns, about 40 microns, about 50 microns, about 75 microns, about 100 microns, about 125 microns, about 150 microns, about 175 microns, about 200 microns, about 225 microns, about 250 microns, about 275 microns, about 300 microns, about 325 microns, about 350 microns, about 375 microns, about 400 microns, about 425 microns, about 450 microns, about 475 microns, about 500 microns, about 525 microns, about 550 microns, about 575 microns, about 600 microns, about 650 microns, about 700 microns, about 750 microns, or any values therebetween, or any ranges bounded by an combination of these values, although other sizes can also be used.

The recess 134b, such as facing down or inward towards the fluid interface, can be offset radially or laterally outward from the recess 134a, such as facing up or outward away from the fluid interface, by a distance 138 of about 2 microns, about 3 microns, about 5 microns, about 7 microns, about 10 microns, about 12 microns, about 15 microns, about 17 microns, about 20 microns, about 25 microns, about 30 microns, about 35 microns, about 40 microns, about 45 microns, about 50 microns, about 55 microns, about 60 microns, about 70 microns, about 80 microns, about 90 microns, about 100 microns, or any values therebetween, or any ranges bounded by any combination of these values, although other configurations could have other distance values outside these ranges. The offset 138a between the recesses 134a and 134b on the radially or laterally outer side can be substantially the same as the offset 138b between the recesses 134 and 134b on the radially or laterally inner side. In some cases, the offset distances 138a and 138b (and/or the widths 136 of the two recesses 134a and 134b) can be different by about 2%, by about 3%, by about 4%, by about 5%, by about 7%, by about 10%, by about 12%, by about 15%, by about 20%, by about 25%, by about 30%, by about 40%, by about 50%, by about 75%, or more, or any values therebetween, or any ranges bounded by any combination of these values, although other configurations are also possible. This disclosure is contemplated as including the ratios and comparisons between the various dimensions of the various features discussed herein and/or shown in the figures.

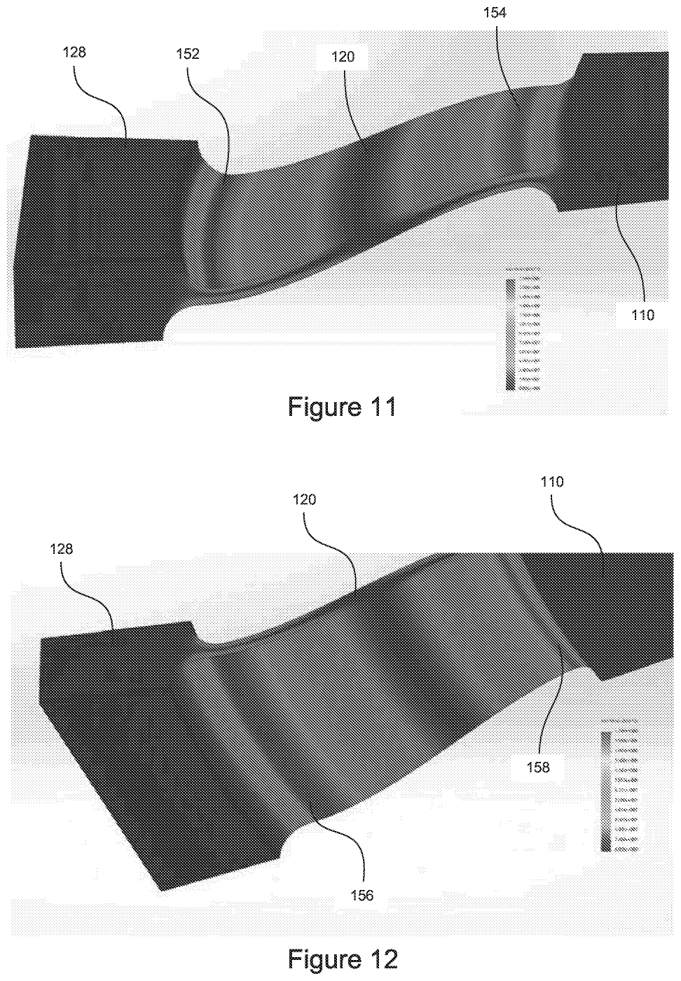

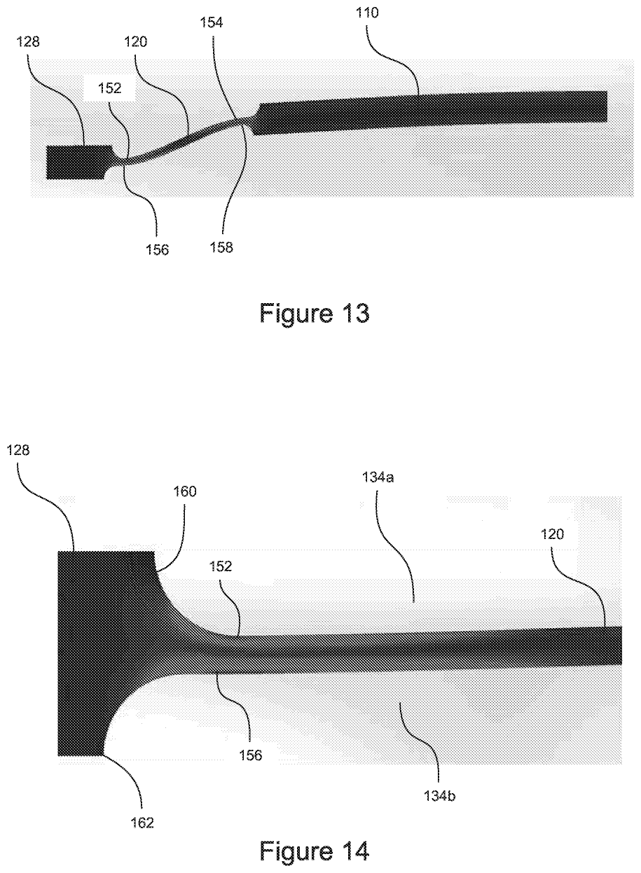

FIG. 11 is a partial perspective view of an example embodiment of a window element in a displaced or flexed configuration, showing an upper side thereof. FIG. 12 is a partial perspective view of an example embodiment of the window element in the displaced or flexed configuration, showing the lower side thereof. FIGS. 13 and 14 are partial cross-sectional views of the example embodiment of the window element in the displaced or flexed configuration. FIGS. 11 and 12 include only a “pie slice” of the window element, and in some cases, the window element can have some or all of the features being rotationally symmetrical. The liquid lens window element is discussed in connection with an upper window 110 of a liquid lens 100, but a similar window element could be used as the lower window element 108 in a liquid lens 100. In FIGS. 11-14, the window 110 is displaced upward or away from the fluid interface, such as shown in FIG. 3. FIGS. 11-14 have shading to show stress applied to the flexure 120 in the displaced or flexed state. When the window 110 is displaced, portions of the flexure 120 can experience compressive stress while other portions can experience tensile stress. When displaced or flexed as shown in FIGS. 11 and 12, the flexure 120 has a first area 152 which experiences compressive stress (e.g., the laterally outer portion of the upper side that faces away from the fluid interface), a second area 154 which experiences tensile stress (e.g., the laterally inward portion of the upper side that faces away from the fluid interface), a third area 156 which experiences tensile stress (e.g., the laterally outward portion of the lower side that faces towards the fluid interface), and a fourth area 158 which experiences compressive stress (e.g., the laterally inward portion of the lower side that faces towards the fluid interface). In some cases, the material can have different compressive and tensile strengths. For example, a glass material can have relatively low tensile strength and relatively high compressive strength.

The flexure 120 can be designed to spread the tensile stress over a larger area than the compressive stress. As can be seen in FIG. 14, for example, the tensile stress applied to area 156 extends farther out onto the flexure 120 (towards the right in FIG. 14) than the compressive stress applied to area 152. Also, in FIGS. 11 and 12, comparing the tensile stress area 156 with the compressive stress area 152 shows that the high stress shading extends farther out onto the flexure 120 structure. The offset between the recesses 134a and 134b can provide a body 160 of the material that is disposed on the side of the flexure opposite the tensile stress area (e.g., opposite the area 156 in FIG. 14). This body 160 of material can operate as a mandrel so that the flexure 120 starts to “wrap” around the mandrel body 160 of material as the flexure 120 deforms (e.g., upward or in a direction extending from the tensile stress area 156 towards the mandrel body 160). The flexure 120 would not wrap completely around the mandrel body 160 as the flexure 120 deforms, but the flexure 120 starting to “wrap” around the mandrel body 160 can spread the deformation and/or tensile stress farther out onto the flexure 120, as compared to an embodiment where the recesses 134a and 134b are coextensive, with no offset. By spreading the tensile stress over a larger area, the peak tensile stress can be reduced. In some cases, coextensive recesses (e.g., similar to recesses 134a and 134b, but without the offset) can produce substantially equal peak compressive stress (e.g., in an area corresponding to 152) and peak tensile stress (e.g., in an area corresponding to 156) as the flexure deflects. For example, a deflection of the flexure having coextensive recesses with no offset caused substantially equal peak compressive stress on the compressive area (e.g., corresponding to area 152) and tensile stress on the tensile area (e.g., corresponding to area 156), which were both higher than 1.744×10⁸ N/m². By comparison, a deflection of the flexure 120 as in FIGS. 11-14, with offset recesses 134a and 134b, caused about 1.744×10⁸ N/m² of peak compressive stress (e.g., on area 152) and about 1.65×10⁸ N/m² of peak tensile stress (e.g., on area 156). The offset recesses 134a and 134b can produce a peak tensile stress (e.g. at area 156) that is lower than the peak compressive stress (e.g., at area 152). In some examples, a liquid lens having the offset recesses 134a and 134b, and/or the mandrel body 160, can reduce the peak tensile stress as compared to a liquid lens with coextensive recesses, and the reduction in peak tensile stress can be about 3%, about 5%, about 7%, about 9%, about 10%, about 12%, about 15%, about 17%, about 20%, about 25%, or more, or any values or ranges therebetween. The offset recesses 134a and 134b can produce a flexure 120 that is less compliant than one having coextensive recesses, so that both the peak compressive stress and the peak tensile stress can be lower for the embodiment having the offset recesses 134a and 134b. Comparing the compression area 152 to the tensile area 154 in FIG. 11 shows that the tensile force is distributed over a larger area, with the shading of the peak tensile stress less dark, and that the compressive force is more concentrated and had darker shading for the peak compressive stress.

The mandrel body 160 can be integrally formed (e.g., from a plate of glass or other suitable material) with the remainder of the flexure 120, with the window 110, and/or with the attachment portion 128. In some embodiments, the mandrel body 160 can be different material than the flexure 120, the window 110, and/or the attachment portion 128. The different material can be coupled to the flexure 120 by adhesive, laser welding, sonic welding, or any suitable technique.

The upper recess 134a can be offset from lower recess 134b in a radially or laterally inward direction. The upper recess 134a and the lower recess 134b can overlap for about 40%, about 50%, about 60%, about 70%, about 80%, about 90%, about 95% of the width of the recess 134a or 134b, or any values therebetween, or any ranges bounded therein. The lower recess 134b can have a larger radius of curvature than the upper recess 134a. The annular recesses 134a and 134b can be concentric shapes (e.g., circles), such as when viewed from the top down. The offset can cause the bending of the flexure 120 to be distributed over a larger area, which can reduce the amount of peak stress experienced by the flexure 120.

The flexure 120 can include a bridge portion that is thinner than the window 110 and/or thinner than the attachment portion 128, as described herein. The bridge portion can be formed between the two recesses 134a and 134b. The bridge portion can extend radially or laterally (e.g., between the window 110 and the attachment portion 128). The bridge portion can be substantially linear when in an unflexed or undeflected state. The direction that the bridge portion extends when in the unflexed or undeflected state can vary from a direction orthogonal to the optical axis by no more than about 1 degree, about 2 degrees, about 3 degrees, about 5 degrees, about 7 degrees, about 10 degrees, about 12 degrees, about 15 degrees, about 20 degrees, about 25 degrees, about 30 degrees, or any values therebetween, or any ranges bounded therein. The bridge portion can extend from a position that is about the middle of the thickness of the window 110 to a position that is about the middle of the thickness of the attachment portion. The connection between the bridge portion and the attachment portion 128 can be within about 2%, about 5%, about 7%, about 10%, about 15%, about 20%, about 25%, about 30% of the midpoint across the thickness of the attachment portion 128, or any values therebetween, or any ranges bounded therein. The connection between the bridge portion and the window 110 can be within about 2%, about 5%, about 7%, about 10%, about 15%, about 20%, about 25%, about 30% of the midpoint across the thickness of the window 110, or any values therebetween, or any ranges bounded therein. The connection between the bridge portion and the attachment portion 128 can be spaced apart from both the upper surface and the lower surface of the attachment portion 128. The connection between the bridge portion and the window 110 can be spaced apart from both the upper surface and the lower surface of the window 110. The distance that the connection between the bridge portion and the attachment portion 128 and/or the connection between the bridge portion and the window 110 is spaced apart from the upper and lower surfaces can be about 10 microns, about 15 microns, about 20 microns, about 25 microns, about 30 microns, about 35 microns, about 40 microns, about 45 microns, about 50 microns, or any values therebetween, or any ranges bounded therein, although other values could be used such as for different sizes of liquid lenses.

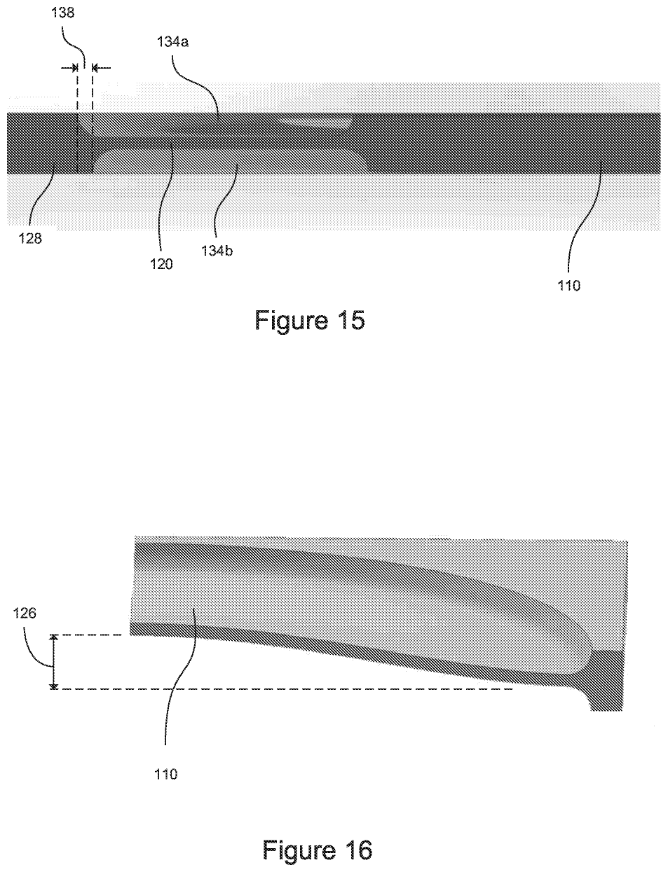

The radially inner recess 134a (e.g., the first recess 134a) can be formed on the top side (e.g., the side facing away from the cavity 102 in the liquid lens 100). The radially outer recess 134b (e.g., the second recess 134b) can be formed on the bottom side (e.g., the side facing towards cavity 102 of the liquid lens 100), although the opposite configuration can be used for a window that is displaced in the opposite direction. The liquid lens could be configured to manage tensile stress when the window 110 moves down or towards the fluid interface. For example, tensile stress would be applied to areas 152 and 158, while compressive stress would be applied to areas 154 and 156. For a liquid lens with the window displaced downward or towards the fluid interface, the upper recess 134a can be offset from lower recess 134b in a radially or laterally outward direction (as shown in FIG. 15), such as by distance 138, in order to distribute the tensile stress over a larger area. Thus, in some embodiments, the parameters (e.g., lateral positions) of the upper recess 134a and the lower recess 134b can be swapped.

The flexures 120 disclosed herein can have any suitable number of recesses. Several embodiments are shown with two recesses 134a-b , although other numbers of recesses can be used, which in some cases can produce undulations in the flexure 120 structure, such as in certain embodiments of the '283 Publication that is incorporated by reference. The various embodiments, features, and details disclosed in the '283 Publication can be applied to various suitable embodiments disclosed herein.

FIG. 16 shows an example of a liquid lens window 110 without a separate flexure 120. FIG. 16 shows the window 110 in a flexed position, such as to can be induced by thermal expansion in a liquid lens. The flexible window 110 can have a substantially constant thickness throughout, which can be thinner than the attachment portion. The axial displacement 126 of the window 110 in FIG. 10 can be significantly less than the axial displacement 126 of the window 110 in FIG. 16, because the deformation of the flexure 120 in FIG. 10 can accommodate a significant amount of the expansion. Also, the window 110 of FIG. 10 can be thicker than the window 110 of FIG. 16 (e.g., because in FIG. 16 the entire window 110 is made thinner and more flexible so that it can accommodate thermal expansion without a dedicated flexure portion 120), which can result in the window 110 of FIG. 10 deforming less. If only the axial displacement of the radially inner portion of the window 110 of FIG. 16 were considered (e.g., the portion having the same radius as the window 110 of FIG. 10), the embodiments of FIG. 10 would still have less window displacement 126. The portion of the window 110 that transmits light that reaches the optical sensor to produce an image can be less deformed in the embodiment of FIG. 10, as compared to the approach of FIG. 16. Thus, the embodiment of FIG. 10 can produce less change in optical power due to temperature changes. The window of FIG. 16 can have a generally Gaussian shape when flexed. The shape of flexed window of FIG. 16 can fit to a fourth order curve, which can introduce optical aberration. The window of FIG. 10 can have a generally spherical or parabolic shape, which can produce less optical aberration than flexed window shape of FIG. 16. In some cases, the shape of the flexed window 110 of FIG. 10 can fit a second order curve. In some cases, etching away significant amounts of material to form the thin window of FIG. 16 can cause undesired variations in thickness in the window, such as due to imperfections in the etching process. These variations can cause optical aberrations, such as astigmatism and wedge, etc., especially as different areas of the window bend at different degrees as the window is flexed. The window 110 of some embodiments can be the full thickness of the material (e.g., glass plate), or only a small amount of material is removed (e.g., etched) to form the depressions 140 and/or 142, which can reduce or avoid the variations, and can produce better optical quality.

Although this disclosure contains certain embodiments and examples, it will be understood by those skilled in the art that the scope extends beyond the specifically disclosed embodiments to other alternative embodiments and/or uses and obvious modifications and equivalents thereof. In addition, while several variations of the embodiments have been shown and described in detail, other modifications will be readily apparent to those of skill in the art based upon this disclosure. It is also contemplated that various combinations or sub-combinations of the specific features and aspects of the embodiments may be made and still fall within the scope of this disclosure. It should be understood that various features and aspects of the disclosed embodiments can be combined with, or substituted for, one another in order to form varying modes of the embodiments. Any methods disclosed herein need not be performed in the order recited. Thus, it is intended that the scope should not be limited by the particular embodiments described above.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. The headings used herein are for the convenience of the reader only and are not meant to limit the scope.

Further, while the devices, systems, and methods described herein may be susceptible to various modifications and alternative forms, specific examples thereof have been shown in the drawings and are herein described in detail. It should be understood, however, that the disclosure is not to be limited to the particular forms or methods disclosed, but, to the contrary, is intended to cover all modifications, equivalents, and alternatives falling within the spirit and scope of the various implementations described. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication.

The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including ambient temperature and pressure.

1. A liquid lens comprising:
a chamber having a volume;
a first fluid contained in the chamber;
a second fluid contained in the chamber;
an interface disposed between the first fluid and the second fluid;
one or more first electrodes insulated from the first fluid and the second fluid; and
one or more second electrodes in electrical communication with the first fluid, a position of the interface based at least in part on a voltage applied between the first electrode and the second electrode;
a window configured to transmit light therethrough along an optical axis; and
a flexure configured to cause the window to displace axially along the optical axis to change the volume of the chamber, wherein the flexure extends laterally outward from the window substantially linearly, wherein the flexure is formed between a first recess on an outer side of the liquid lens and a second recess on an inner side of the liquid lens, and wherein the second recess extends laterally outward farther than the first recess.

2. The liquid lens of claim 1, comprising an attachment portion, wherein the flexure extends between the window and the attachment portion.

3. A liquid lens comprising:
a chamber having a volume;
a first fluid contained in the chamber;
a second fluid contained in the chamber;
an interface disposed between the first fluid and the second fluid;
one or more first electrodes insulated from the first fluid and the second fluid; and
one or more second electrodes in electrical communication with the first fluid, wherein a position of the interface is based at least in part on a voltage applied between the first electrode and the second electrode;
a window element comprising:
a window configured to transmit light therethrough along an optical axis;
an attachment portion coupled to an underlying structure of the liquid lens;
a first recess on a first side of the window element; and
a second recess on a second side of the window element, wherein material between the first recess and the second recess provides a flexure that extends between the window and the attachment portion, wherein the first recess and the second recess are offset from each other so that displacement of the window and flexure produces less peak tensile stress than peak compressive stress on the flexure.

4. The liquid lens of claim 2, wherein the flexure couples to the attachment portion at a middle of a thickness of the attachment portion.

5. The liquid lens of claim 1, wherein the flexure couples to the window at a middle of a thickness of the window.

6. The liquid lens of claim 1, wherein the first recess extends laterally inward farther than the second recess.

7. The liquid lens of claim 1, wherein the first recess and the second recess have substantially the same widths.

8. The liquid lens of claim 1, wherein the first recess and the second recess have substantially the same depths.

9. The liquid lens of claim 1, wherein the flexure is made of the same material as the window.

10. The liquid lens of claim 1, wherein the flexure is integrally formed with the window.

11. The liquid lens of claim 1, wherein the window and the flexure are made of glass.

12. The liquid lens of claim 1, wherein:
when the liquid lens is in a flexed state, the window is axially displaced by a flexure displacement distance from bending of the flexure and the window is axially displaced by a window bend distance from bending of the window; and
the flexure displacement distance is greater than the window bend distance.

13. The liquid lens of claim 12, wherein when the liquid lens is in the flexed state, a ratio of the flexure displacement distance to the window bend distance is at least 2 to 1.

14. The liquid lens of claim 12, wherein when the liquid lens is in the flexed state, a ratio of the flexure displacement distance and the window bend distance is at least 4 to 1.

15. The liquid lens of claim 13, wherein the ratio is less than or equal to 12 to 1.

16. The liquid lens of claim 1, wherein the window is flexible, and the flexure is more flexible than the window.

17. The liquid lens of claim 1, wherein the window flexes to have a substantially spherical curvature or a substantially paraboloidal curvature.

18. The liquid lens of claim 1, wherein the flexure is positioned circumferentially around the window.

19. The liquid lens of claim 1, wherein the first fluid and the second fluid are substantially immiscible to form the interface between the first fluid and the second fluid.

20. A camera system comprising:
the liquid lens of claim 1; and
a camera module comprising:
an imaging sensor; and
one or more fixed lenses configured to direct light onto the imaging sensor, wherein operating the camera module produces heat that causes a change in a focal length of the one or more fixed lenses;
wherein the liquid lens is thermally coupled to the camera module such that at least a portion of the heat from the camera module is transferred to the liquid lens, wherein the heat transferred to the liquid lens flexes the window to produce a change in a focal length of the liquid lens that at least partially counters the change in the focal length of the one or more fixed lenses in the camera module.
